(19) United States
(12) Patent Application Publication
(10) Pub. No.: US 2012/0066749 A1
(43) Pub. Date: Mar. 15, 2012

(54) METHOD AND COMPUTER PROGRAM FOR GENERATION AND VERIFICATION OF OTP BETWEEN SERVER AND MOBILE DEVICE USING MULTIPLE CHANNELS

(75) Inventors: Petter Taugbøl, Oslo (NO); Arne Riiber, Oslo (NO)

(73) Assignee: ENCAP AS, Oslo (NO)

(21) Appl. No.: 13/254,199

(22) PCT Filed: Mar. 2, 2010
(86) PCT No.: PCT/NO2010/000084

§ 371 Date: Oct. 31, 2011

(30) Foreign Application Priority Data
Mar. 2, 2009 (NO) 20090934

(51) Int. Cl. G06F 21/20

(52) U.S. Cl. 726/6

(57) ABSTRACT

A method and computer program for generation and multi channel verification of OTP (One Time Password) between two parties consisting of a service provider and a user, wherein said user has access to at least two communication channels, and wherein said user is logging into said service provider with a user ID via one communication channel and the service provider has the ability to communicate with an authentication server which again has the ability to communicate with said user via at least one other communication channel than the service provider.

### FIELD OF THE INVENTION

The present invention relates to the field of user authentication in an electronic environment using OTP (One Time Password), and more particularly to the use of at least two channels for verification of OTP between server and mobile device.

### BACKGROUND OF THE INVENTION

Providers of services in electronic channels are faced with the challenges of authenticating the users of their services. The ability to provide secure user authentication is necessary for many electronic services. A user could be a person using a service, such as an Automatic Teller Machine, but a user could also be a machine that needs to communicate with another machine, e.g. an automatic system that needs to access data stored in a database or file a report to that database.

Service providers that require strong user authentication often issue one or several authentication factors to a user, which the service provider later can use to authenticate the user. If the user is issued with more than one authentication factor, and the user is required to provide all authentication factors at an authentication incident, the risk of false incidents is greatly reduced. If, in addition, the authentication factors are of different nature, and each give a unique identification of the user, and the authentication data produced are secret to others than the user and the service provider, the authentication solution becomes what is known in the art as a strong multi factor authentication solution.

Authentication factors commonly used are a knowledge factor (̂something you know’, like a password or PIN code) and a possession factor (^{λ} something you have’, like an electronic one time password generator, a security client with private encryption keys stored in computer memory or on a chip card, printed lists of one time pass codes, scratch cards and others). In addition, biometric data (̂something you are’, like digital representations of a fingerprint or iris scan) is sometimes used as an authentication factor.

Possession factors are often physical of nature, like chip cai'ds, password calculators/tokens, or scratch cards. Issuing physical possession factors represents often a significant cost for service providers and is often viewed as inconvenient by the users. Therefore, it can be of interest to service providers and users to utilise a general available personal data terminal already in the hands of the user as a secure possession factor. Examples of personal terminals that can be attractive to utilise as possession factors are devices with communication capabilities such as mobile phones, portable computers, handheld computers like PDAs and Smartphones and personal entertainment terminals; for all these the term “mobile” is herein used as a generic term.

Several methods where personal data terminals are used for user authentication are known.

One known method is where a service provider registers the mobile subscription numbers of users and in an authentication process distributes a shared secret to the mobile terminal of the user, requiring the user to return the shared secret in another electronic channel. The weaknesses with this method are that the sender (service provider) can not verify the identity of the receiving party (user), the shared secret is produced on a server; hence there is no reference to a possession factor in the authentication response and the mobile device is used as a communication terminal only. Finally, the mobile terminal is not regarded as a safe environment for containing shared secrets, for example can shared secrets be divulged in the network or read by, or redistributed to, another party from the mobile terminal, thereby reducing it to another knowledge factor instead of a possession factor—i.e. there are now two knowledge factors (password plus password sent by sms)—which is not a true two-factor solution.

IETF RFC 4226 (http://www.ietf.org/rfc/rfc4226) from December 2005 describes an algorithm to generate one-time password values, based on Hashed Message Authentication Code, to be used as two-factor authentication on the Internet. The Internet Draft “OCRA: OATH Challenge-Response Algorithms draft-mraihi-mutual-oath-hotp-variants-08.txt” (http://tools, ietf.org/html/draft-mraihi-mutual-oath-hotp-variants-08) describes the OATH algorithm for challenge-response authentication and signatures. This algorithm is based on the HOTP algorithm in RFC4226.

IETF RFC 2289 (http://www.ietf.org/rfc/rfc2289) from February 1998 describes a One-Time Password System

WO/2006/075917 teaches a method for producing a security code by means of a programmable user device that can be used for authentication.

“Using the mobile phone in two-factor authentication” presented at IWSSI2007 by Anders Hagalisletto and Anders Riiber (http://www.comp.lanes.ac.uk/iwssi2007/papers/iwssi2007-05.pdf) teaches how to use a mobile phone for displaying a One Time Password.

KR20080011938A teaches a method where the user's identity is authorized by a server that sends an SMS with a module for generating OTP in the mobile when a PIN is input.

WO2009009852A2 teaches a method for transferring credits using a mobile device for generating OTP that is displayed based on a personal password and codes.

WO2007/145540A teaches two-factor authentication with a separate channel to the authentication system and the use of a password on the mobile device. It is suggested to use a wireless channel in addition, but with the same OTP.

DE10102779A1 teaches a mobile phone transaction authorization system that has separate links to separate units in the same equipment.

EP1919123A1 teaches a dual channel challenge-response authentication method where the response matches a subset of authentication credential identified by the session authentication challenge.

In “Multi-channel protocols” by Ford-Long Wong and Frank Stajano in B. Christianson et al. (Eds.): Security Protocols 2005, LNCS (http://www.cl.cam.ac.uk/˜fms27/papers/2005-WongSta-multichannel.pdf) the use of multiple channels is discussed. Using a camera phone and sending pictures is suggested as a channel.

Some additional problems with these solutions are:
The probability of successful authentication for a false authentication attempt for an arbitrary OTP is greater than 1 over 10 E (the number of digits) for offline digit based OTP devices, making it possible to create automated distributed attacks that run until successful authentication of an arbitrary OTP.
Denial of Service (DOS) attacks can be launched locking OTP device on server, preventing access for users with proper OTP device
Slow network access for online mobile OTP devices (a problem relevant for online multi channel OTP devices)—making the user have to wait for client/server communication before the OTP can be displayed. (This problem is not present for offline OTP devices.)
MITM (Man in the Middle) attacks in a one channel online authentication solution, where the OTP is transferred using an assumed secure data channel, for example HTTPS.

When multiple channels are used systematically in a system for authentication and verification, there is always a chance that one channel could have errors or communication problems, or the user could have problems with providing information in the channel, e.g. due to a handicap. There is then a need for more flexible handling of the verification result, than just stating that authentication has failed.

### SUMMARY OF THE INVENTION

The subject matter of the present invention is a method, arrangement and computer program for utilizing a generally available personal data terminal, a mobile, as a secure and reliable possession factor during user authentication. The features defined in the independent claims enclosed characterize this method and arrangement.

The present invention includes a local OTP generation, with simultaneous dual/multi channel verification. It also allows for a flexible handling of the result of the authentication. This gives at least the following advantages:
More resistance to DOS-attacks.
Upgrade of systems is facilitated, as more channels can be added gradually.
The length of the OTP may be adapted to the channel. The OPT displayed to the user must be easy to enter, whereas the OTP send over a digital channel could typically be 16 bytes. This reduces the chance for a MITM to succeed with a randomly generated OTP.
The authentication server can start the authentication as the first OTP arrives, and then verify it using the others. This increases processing speed.

Prior art includes:
Offline OTP devices that have local OTP generation and single channel verification.
Online OTP devices that have client/server communication e.g. to get a challenge, and single channel verification when the device displays an OTP to the user.
Online two-factor authentication with a separate channel to the authentication system using a password on the mobile device to generate an authentication token

In a preferred embodiment of the present invention the user enters PIN and produces binary-OTP in the client, the binary-OTP is converted to a readable display-OTP on client so that the user can start reading it and typing it into a second channel, simultaneously with the transmission of the binary-OTP on the mobile channel (the first channel). It is simultaneous, because the mobile transmits the binary-OTP on the mobile channel while the user reads and types the display-OTP on the 2^{nd} channel. The display-OTP is derived from the binary-OTP. The binary-OTP being in a format suitable for data communication and computing (e.g. raw binary, or encoded, e.g. in hexadecimal notation or baseβ4, or Unicode) and the display-OTP is suitable for a human to read on a display and enter on a keyboard, e.g. in the characters and numerals ordinary used by the user or service or to be read by a technical reader like a barcode. As shown in FIGS. 2, 3 and 4 the binary-OTP is generated in the mobile device, and so is the mapping to the display-OTP. In the case of machine-to-machine communication, i.e. where the user is a machine, the term “display otp” is not to be taken literally, as it may be handled by a process in the machine and never be displayed.

The following principles apply:

Two channel verification of OTP.
Local OTP generation, with (simultaneously) dual or multi channel verification and response of OTP verification on o mobile channel (s), e.g.
SMS
Near Field Communications
Wireless LAN
Line or packet switched cellular transmission technologies such as CDMA, WCDMA, GSM, GPRS, 3G, 4G
a) other channel (s), e.g. a) a PC with a web channel used for internet banking,
b) a door access control, physical access to parking lots etc.
c) Point of Sale
d) Automated Teller Machine

The user does not have to wait for the verification of binary-OTP. The user can start to type it immediately, because the local conversion from binary-OTP to display-OTP in practice is much faster than the transmission time over the mobile network. If the user types the wrong PIN or otherwise produces a wrong binary-OTP, the user is informed that authentication failed on both channels when the result of the verification is ready on server.

If binary-OTP is wrong, the verification of binary-OTP will fail. The verification of display-OTP will also fail, since the verification of binary-OTP failed.

If a time-out occurs in the Authentication server because it has not received binary-OTP, verification of the display-OTP may fail, since verification of binary-OTP has not been successful. The time-out may be caused by natural transmission delay, or caused by an attacker.

It is possible to set up rules and parameters that can allow authentication in special situation like a network outage, i.e. where it is known that a time-out is likely or if it is known that a particular user has problems with entering the display-OTP, e.g. due to a handicap.

It is also possible to use e.g. text to voice and voice recognition software, or to involve call centers, to enable handicapped persons to use the present invention.

It is also possible to prevent DOS attacks from an attacker entering four consecutive wrong OTPs in the web channel, (compared to off-line OTP devices), since the verification of display-OTP (over the web channel) may be neglected if not the binary-OTP (over the mobile channel) has been successfully verified.

The verification of binary-OTP between the mobile and server increases the security related to the length of the OTP, to be perceived by a MITM (Man In The Middle) as a random number, since the display-OTP is typically a 4-8 digits number that can be encoded as 2-4 bytes, while the binary-OTP is a number of at least 16 bytes, easily extensible to 32 bytes or more. Thus the probability of e.g. by trial and error finding or guessing a binary-OTP is much lower than the probability of finding a display-OTP.

Compatible interfaces with traditional challenge/response offline OTP devices can be used for integrating a new multi channel OTP verification scheme according to the present invention into an existing one channel, for example time/sequence based offline OTP devices or challenge response scratch cards, making it possible to replace offline single channel OTP verification mechanisms with the present invention.

It is impossible for a MITM between the Authentication client and the Authentication server to observe the display-OTP on the mobile channel, since this OTP is not transferred on that interface. The display-OTP is generated by the Authentication client and shown to the User, based on binary-OTP and PIN (Personal Identification Number).

The use of PIN may be optional. Typically the use of PIN is then enabled by a configurable parameter per system or device. If a PIN is not used, the mapping between binary-OTP and display-OTP is either the same algorithm without PIN or a particular algorithm for that particular client to be used in the case of use without PIN, known to the authentication server.

In another embodiment of the present invention the method may be used in a physical access control system where the binary OTP is sent via the mobile channel and the display OTP is entered by the user on the numerical keyboard at the entrance. Access is allowed based on the combined verification result in an Access Control server.

In yet another embodiment the present invention may also be used in a system where the user wants to withdraw cash at an ATM or a manned POS terminal at a cash handling agent in a typical MMU-system (Mobile Money for Un- or Underbanked markets). Instead of initiating the withdrawal with a bankcard and PIN, the user initiates the withdrawal with his mobile phone, sending an sms to a service provider indicating the ATM number or Merchant number and the amount to be withdrawn. The service Provider starts the authentication process and in parallel with the binary OTP being sent from the user device to the authentication server for verification, the display-OTP is read and entered by the user on the ATM or POS-terminal keyboard as a one-time PIN-code. When both are verified ok, the Service Provider authorizes that the money shall be cashed out. This assumes that the ATM- or POS-terminal service has been programmed accordingly.

The present invention advantageously provides a method and system for control room screens which can be designed having a hierarchy of different layers from the detailed object process display all way up to the overview display.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 gives an example of the components involved in a dual band verification sequence in an embodiment consisting of a mobile phone and a computer;

FIG. 2 shows detailed authentication sequence with dual and parallel channel OTP verification;

FIG. 3 shows the user challenge sequence;

FIG. 4 shows a sequence without user challenge;

FIG. 5 shows one alternative method for generating the display-OTP and binary-OTP in the authentication server;

FIG. 6 shows the preferred method for generating the display-OTP and binary-OTP in the authentication server; and

FIG. 7 shows source code from a preferred embodiment for converting binary-OTP into display-OTP.

### DETAILED DESCRIPTION OF THE INVENTION

In summary the present invention has the following features:

Generation and verification of OTP (One Time Password) between two parties consisting of a service provider and a user, wherein said user has access to at least two communication channels, and wherein said user is logging into said service provider with a user ID via one communication channel and the service provider has the ability to communicate with an authentication server which again has the ability to communicate with said user via at least one other communication channel than the service provider, where
An authentication client generates at least two different but interrelated OTPs, at least one binary-OTP, and at least one display-OTP,
said authentication client transmits binary-OTP to said authentication server using at least one communication channel,
said user enters the display-OTP and submits it to said authentication server through said service provider using at least one other communication channel.
When binary-OTP and display-OTP are received by the authentication server they are subject to verification.

The authentication client may requests a challenge from said authentication server and prompts said user for PIN.

The authentication server receives the binary-OTP message and the display-OTP, verifies the binary and display-OTP, makes a verification decision based on a decision algorithm and returns the result in at least one channel.

Generation of OTP can be done both, with or without PIN and with or without challenge.

At least one communication channel is using a mobile device.

The user may log in to the service provider via a web browser The user enters the user

ID on the web login page and submits the page to the Service Provider.

The challenge is returned in the web page.

The challenge may contain text or images to be displayed to and confirmed by the user by entering PIN or an OTP from another application present on the mobile.

The challenge ID associated with the login attempt may also be returned in the web page.

The challenge may be included in a start push message.

The challenge may be generated by the authentication server or by the service provider.

One communication channel could be using Near Field Communication or short distance radio transmission. The implementation is in form of a computer program loadable into the internal memory of a processing unit in a computer based system, comprising software code portions for performing the authentication of the user.

The Computer program product is stored on a computer readable medium, comprising a readable program for causing a processing unit in a computer based system, to control an execution of the authentication of the user.

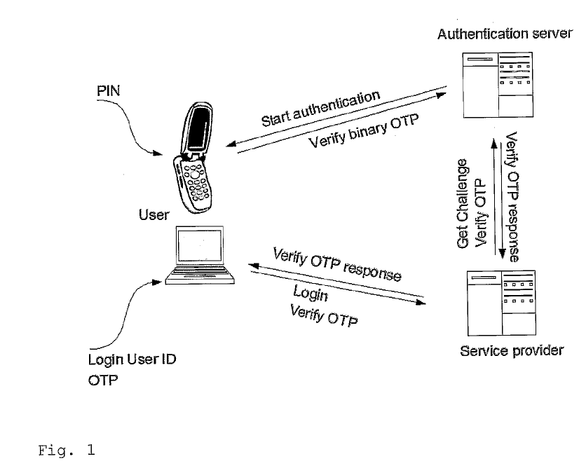

FIG. 1 shows an example of an embodiment of the present invention. It gives an overview of the different components involved in the invention. In this figure it is shown how a user is connected, and logged in, to the service provider.

When the user wants to complete a transaction the service provider connects to the authentication server which again starts an authentication via the user's mobile which has installed specific software from the Authentication authority. This software can be implemented in many ways e.g. depending on the operative system of the mobile. In a preferred embodiment the software is implemented using Java for mobile terminals (MIDP2/J2ME) from Sun. The server in the preferred embodiment is based on the Java enterprise server platform (J2EE).

Once the authentication server starts the authentication process the user has to enter a PIN into the mobile, the software on the phone generates an OTP (the display-OTP) and a binary-OTP, the binary-OTP is sent to the authentication server and the user has to enter the corresponding OTP (display-OTP) in the application communicating with the service provider, usually a web page. The service provider sends the display-OTP to the authentication server which verifies the display-OTP. The authentication server also verifies the binary OTP received from the mobile. The authentication server generates the result of the two verify OTP operations according to rules and parameters, and sends the response to the service provider which again sends the verification response to the user, usually via the web channel to the resulting web page, and also sends the response to the mobile via the mobile channel, usually to the display of the mobile, though it can be complemented or replaced with e.g. sound or tactile response.

If the authentication is initiated by a push message, the authentication server may send the challenge to the authentication client in that message. In an alternative embodiment the challenge is sent in more than one channel.

It can be seen how the authentication and communication is being transmitted via two different communication channels, making it difficult for a foreign party to break into the communication since that person has to be intercepting the communication on two different types of communication links.

The only way for a foreign party to interfere with the transaction is that they have the possibility to interfere in both communication sessions or that they have stolen both the user's computer and mobile phone and know the PIN number and the login information. Both these scenarios are hard to accomplish.

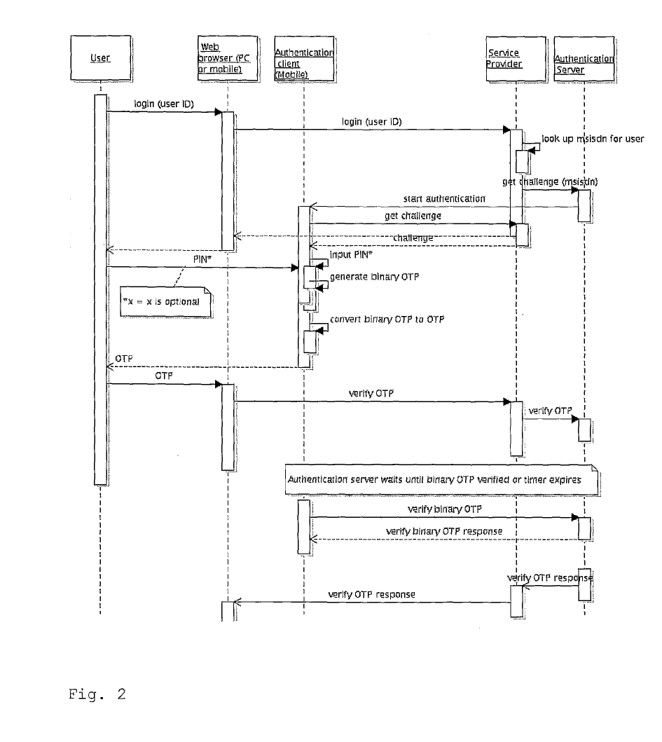

FIG. 2 is a detailed description of the authentication sequence for a challenge/response scenario.

The User enters the user ID on the web login page and submits the page to the Service Provider.

The user ID can be any kind of user specific information like a PIN-number, a telephone number, social security number, a self chosen or system generated ID, or a code or even a biometric input. The User ID is unique for a single user. A user need not to be a single person, but could be used by a group of people, but in a preferred embodiment the User ID uniquely identifies one person.

The Service Provider looks up the mobile phone number (msisdn) of the user and sends a challenge request to the Authentication Server. The challenge is returned in the web page (or in code from the web page) to the User. The challenge contains or initiates text instructing the User to enter the OTP from another application present on the mobile. A challenge ID associated with the login attempt is also returned in the web page (or in code from the web page) to the User, this allows several outstanding non-completed logins for a challenge/response solution, but multi channel verification also works without this challenge ID.

Push messages are specially formatted messages that can be sent via SMS or other protocols, containing text, XML, or binary content that e.g. may display an alert and let the user connect directly to a website via the browser, rather than having to type in an address, or start an application.

The Authentication Server sends a push start authentication message to the Authentication Client on the mobile of the User. The Authentication server has knowledge of something from the Authentication client that can be used for generating the OTPs. In the preferred embodiment this is as described in WO/2006/075917 and by using the challenge.

The Authentication Client requests a challenge from the Authentication Server, if this was not included in the initial message, and prompts the user for PIN.

The Authentication Client generates binary-OTP, converts it to a human readable display-OTP, displays this, and starts transmitting the binary-OTP to the Authentication Server. The transmission delay in a typical low bandwidth mobile channel is indicated in the figure by postponing the message “verify binary-OTP” to after the web browser has submitted OTP (display-OTP).

The User types the display-OTP in the web browser and submits it to the Authentication Server through the Service Provider.

The Authentication Server waits for a configurable time until binary-OTP is verified, or has timed out.

The Authentication Server receives the “verify binary OTP” message, verifies the binary and display-OTP, and returns the result in both channels.

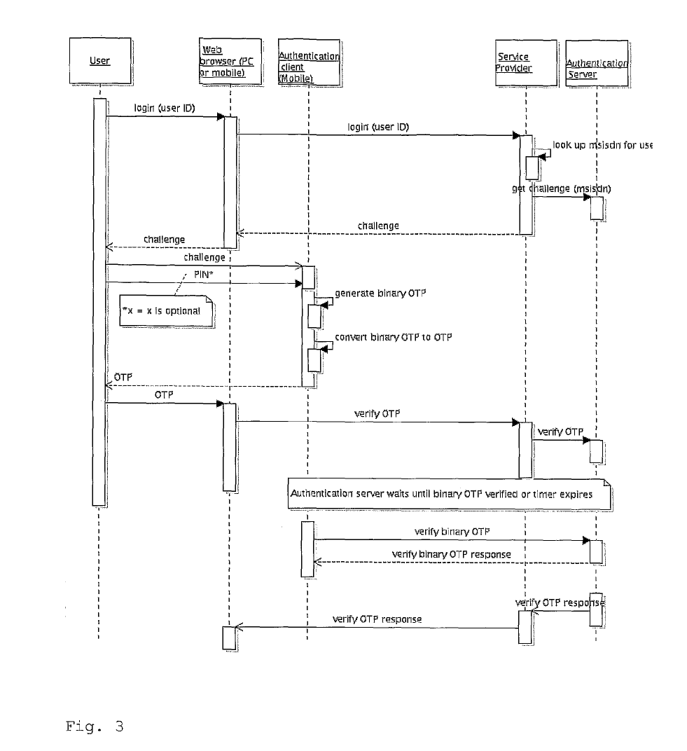

FIG. 3 illustrates the authentication sequence for an OTP device where the user receives the challenge from the web page, starts the client, and enters the challenge into the client.

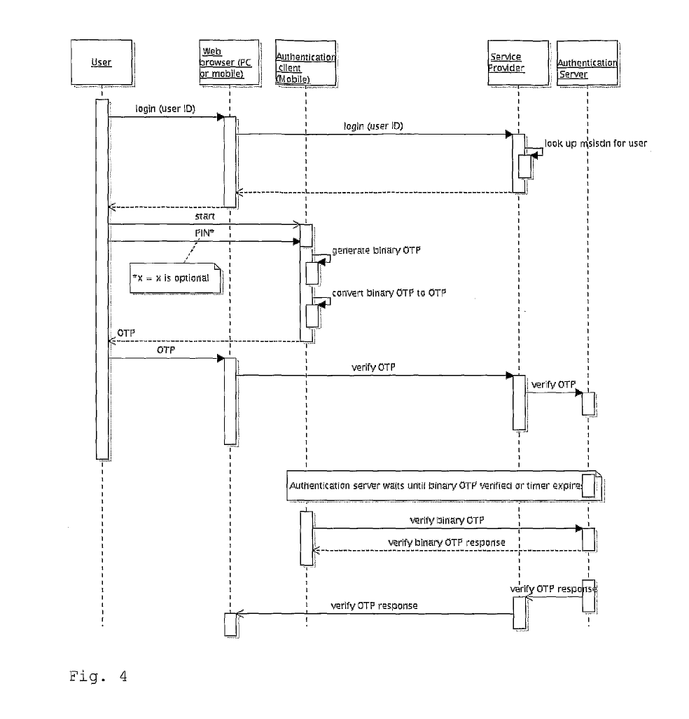

FIG. 4 illustrates the authentication sequence for an OTP device without challenge. The user starts the client manually.

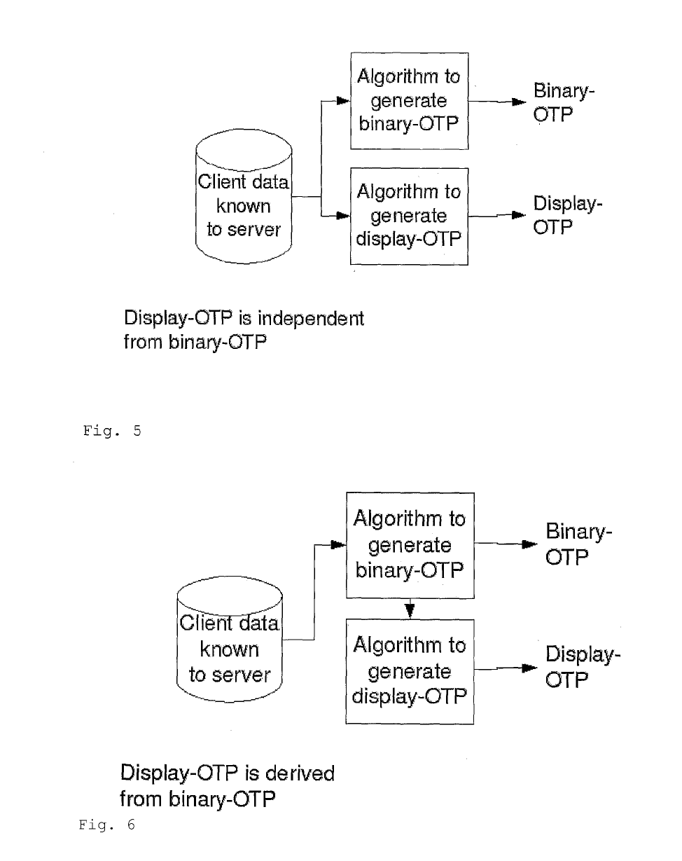

FIG. 5 illustrates one method for generating the display-OTP and binary-OTP in the authentication server. A similar process takes place in the authentication client. In this embodiment the display-OTP and the binary-OTP are generated using different algorithms and could also be based on two sets of data stored with the user profile. An algorithm that could be used is lookup tables as described in [RFC2289].

FIG. 6 show the preferred method for generating the display-OTP and binary-OTP in the authentication server. A similar process takes place in the authentication client. The display-OTP is derived using the binary-OTP combined with an algorithm. In this preferred embodiment the following algorithms are used:
to generate binary-OTP the challenge response taught by WO/2006/075917
to generate display-OTP: The generateOTP ( ) method from RFC4226, with:
   binary-OTP as the key (instead of the HMAC-SHA1 as the key method described in RFC4226), and
   challenge as the movingFactor, and
   configurable number of digits to display

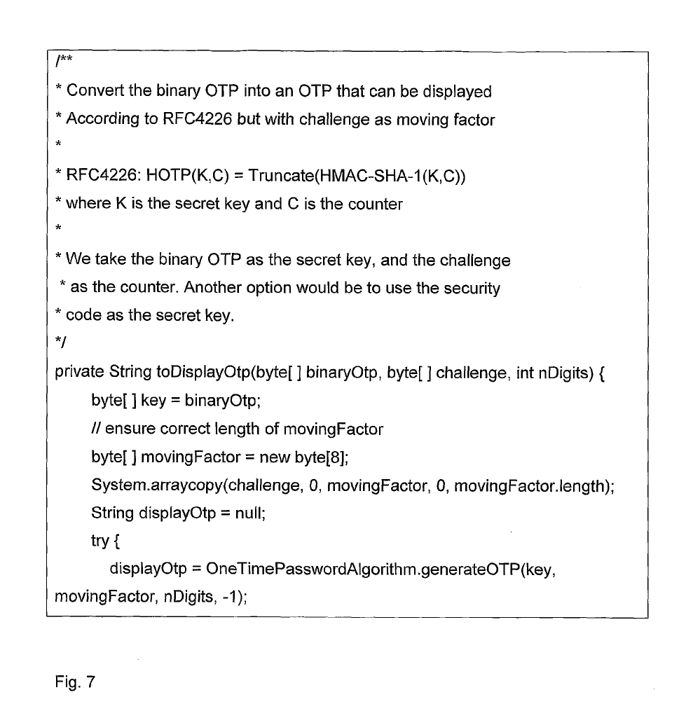

FIG. 7 illustrates this with the source code for this step of the preferred embodiment. Here the binary-OTP is 16 byte and the display-OTP is 6 digits, usually 3 byte. This ensures a user friendly display-OTP and a longer, more secure binary-OTP.

Near Field Communication (NFC) is a short-range high frequency wireless communication technology which enables the exchange of data between devices up to about 10 centimeter distance, thus having a much shorter range than e.g. Bluetooth or other short range radio communications links. NFC is available in mobiles like Nokia 3220 and more recent models from this and other vendors. NFC is suitable for authentication purposes as the possession factor has to be brought very close to the other unit and the radio channel thus is hard to intercept.

In another embodiment the binary OTP generated on the mobile device is transmitted to a service provider using NFC.

In yet another embodiment the binary OTP generated on the mobile device is transmitted to a service provider using a short range radio transmission link such as Bluetooth.

In yet another embodiment the OTP device and possession factor with the authentication client is in form of memory, e.g. on a card connected to the mobile phone or PC (host device) that has the display, processor and communication channels needed. The card could be e.g. a Subscriber Identity Module (SIM, a USB mass storage or an SD card. In this embodiment the two communication channels must be separated by the host device.

In yet another embodiment the display-OTP is DTMF and transferred to the authentication server by the client on the mobile terminal using the circuit switched telephone line. This can be useful in e.g. telephone banking scenarios.

In yet another embodiment, the dual channel verification scheme may be implemented to allow tolerant or strict verification. For example, a blind, weak sighted and/or dyselectic user may have difficulties reading OTP on the display of the mobile terminal, but are capable of entering correct PIN, causing correct binary OTP verification on the mobile channel.

A number of decision algorithms may be used, including weighting of the result from the channels or using neural networks; a simple implementation using table look up and a Boolean function. This is shown in the following two tables illustrating variations of server tolerance for authenticating

TABLE 1
tolerant verification.

| | binary-OTP | display-OTP | |
|---|---|---|---|
| Case | verified | verified | User authenticated |
| 1 | no | no | no |
| 2 | no | yes | yes |
| 3 | yes | no | yes |
| 4 | yes | yes | yes |

User is authenticated when OTP is verified successfully in one of the channels.

TABLE 2
strict verification.

| | binary-OTP | display-OTP | |
|---|---|---|---|
| Case | verified | verified | User authenticated |
| 1 | no | no | no |
| 2 | no | yes | no |
| 3 | yes | no | no |
| 4 | yes | yes | yes |

User is authenticated when OTP is verified successfully in two channels.

A dual channel verification scheme can be viewed as a special case of a multi channel verification scheme.

In another embodiment, the authentication server has a number of channels to verify OTP, and a configurable number of authentication channels that must be successful to satisfy the condition “User authenticated”, depending on the threat level. The configuration may be dynamic based on a feedback loop, for example based on the activity from certain IP address ranges, or based on knowledge of network problems or user handicap.

In another embodiment the user is a machine, and the display-OTP is read by a process in the machine, and then sent in another channel than the binary-OTP.

1. A method for generation and verification of OTP (One Time Password) between two parties consisting of a service provider and a user, wherein said user has access to at least two communication channels, and wherein said user is logging into said service provider with a user ID via one communication channel and the service provider has the ability to communicate with an authentication server which again has the ability to communicate with said user via at least one other communication channel than the service provider, wherein said method is further characterized by that:
An an authentication client, generates at least two different but interrelated OTPs, at least one binary-OTP, and at least one display-OTP;
said authentication client transmits binary-OTP to said authentication server using at least one communication channel;
said user enters the display-OTP and submits it to said authentication server through said service provider using at least one other communication channel; and
when binary-OTP and display-OTP are received by the authentication server they are subject to verification.

2. A method for generation and verification of OTP according to claim 1, characterized by that said authentication client requests a challenge from said authentication server and prompts said user for PIN.

3. A method for generation and verification of OTP according to claim 1, characterized by said authentication server receives the multiple otp-messages, verifies the OTPS, makes a verification decision based on a decision algorithm and returns the result in at least one channel.

4. A method for generation and verification of OTP according to claim 2, characterized by that generation of OTP can be done both, with or without PIN and with or without challenge.

5. A method for generation and verification of OTP according to claim 1, characterized by that at least one communication channel is using a mobile device.

6. A method for generation and verification of OTP according to claim 1, characterized by that said user log in to service provider via a web browser.

7. A method for generation and verification of OTP according to claim 1, characterized by that said user enters the user ID on the web login page and submits the page to the Service Provider.

8. A method for generation and verification of OTP according to claim 2, characterized by that said challenge is returned in the web page.

9. A method for generation and verification of OTP according to claim 2, characterized by that said challenge contains text or images to be displayed to and confirmed by the user by entering PIN or an OTP from another application present on the mobile.

10. A method for generation and verification of OTP according to claim 2, characterized by that a challenge ID associated with the login attempt is also returned in the web page.

11. A method for generation and verification of OTP according to claim 2, characterized by that said challenge is included in a start push message.

12. A method for generation and verification of OTP according to claim 2, characterized by that said challenge is generated by the authentication server or by the service provider.

13. A method for generation and verification of OTP according to claim 1, characterized by one communication channel using Near Field Communication or short distance radio transmission.

14. Computer program loadable into the internal memory of a processing unit in a computer based system, comprising software code portions for performing the authentication of said user in accordance with claim 1.

15. Computer program product stored on a computer readable medium, comprising a readable program for causing a processing unit in a computer based system, to control an execution of the authentication of said user in accordance with claim 1.
